(19) United States
(12) Patent Application Publication
(10) Pub. No.: US 2014/0168041 A1
(43) Pub. Date: Jun. 19, 2014

(54) REFERENCE VOLTAGE GENERATOR OF GATE DRIVING CIRCUIT AND REFERENCE VOLTAGE GENERATING METHOD

(71) Applicant: UPI SEMICONDUCTOR CORP., Hsinchu County (TW)

(72) Inventors: Wei-Jung Chen, Hsinchu County (TW); Sheng-Chiun Lin, Hsinchu County (TW)

(73) Assignee: UPI SEMICONDUCTOR CORP., Hsinchu County (TW)

(21) Appl. No.: 13/792,234

(22) Filed: Mar. 11, 2013

(30) Foreign Application Priority Data
Dec. 14, 2012 (TW) 101147616

(51) Int. Cl. G05F 3/02; G09G 3/36

(52) U.S. Cl. CPC G05F 3/02; G09G 3/3696
USPC 345/87; 323/313

(57) ABSTRACT

A reference voltage generator of a gate driving circuit is provided. The reference voltage generator includes a temperature sensing unit, a level clamp unit, a gain adjusting unit and a computing circuit. The temperature sensing unit generates a temperature sensing voltage in response to an environmental temperature. The level clamp unit is coupled to the temperature sensing unit and providing a difference signal in response to the temperature sensing voltage. The gain adjusting unit is used to provide a temperature compensating gain and a first reference level. The gain adjusting unit adjusts the temperature compensating gain and the first reference level according to a control command. The computing circuit is coupled to the level clamp unit and the gain adjusting unit to provide a reference voltage in response to the temperature compensating gain, the first reference level and the difference signal.

### CROSS-REFERENCE TO RELATED APPLICATION

This application claims the priority benefit of Taiwan application serial no. 101147616, filed on Dec. 14, 2012. The entirety of the above-mentioned patent application is hereby incorporated by reference herein and made a part of this specification.

### BACKGROUND OF THE INVENTION

1. Field of the Invention

The invention relates to a reference voltage generator and a reference voltage generating method, more particularly to a reference voltage generator and a reference voltage generating method for a gate driving circuit of liquid crystal display panel.

2. Description of Related Art

In order to simplify process of fabricating a liquid crystal display (LCD) panel to lower processing costs, a technology has been developed to fabricate a gate driving circuit for the LCD panel on a peripheral circuit region of the LCD panel, said technology is generally called gate on array (GOA) or gate in panel (GIP). Since a LCD apparatus adopting said technology does not require a gate driving IC to be additionally disposed on the peripheral of the LCD panel, an integration of a panel may be increased, so as to further reduce a thickness of the LCD panel. In addition, processing steps of fabricating the LCD may be reduced to lower costs by adopting said technology.

The gate driving circuit on the LCD panel adopting GOA technology is generally fabricated by using thin film transistor (TFT), so as to replace the gate driving circuit originally fabricated by using silicon semiconductor device. However, the gate driving circuit fabricated by a TFT device exhibits a poor performance under low temperature due to device characteristics of the TFT device. Currently, a method used by major panel manufacturers for solving said problem under low temperature is to utilize a reference voltage generator with a temperature compensation function, so as to generate a gate driving voltage required for the gate driving circuit. In which, generally a voltage generator with the temperature compensation function may generate a temperature sensing voltage related to an environmental temperature through an equivalent circuit composed by a thermistor and a common resistor, a characteristics deviation of the gate driving circuit under low temperature may be compensated by adjusting a level of the gate driving voltage generated according to the temperature sensing voltage.

Nevertheless, gate driving circuits designed by different manufacturers usually have different operating voltages and low temperature compensating voltage, so that characteristic curves of the gate driving voltages required may also be different. When the gate driving voltage is generated by using said method, hardware parameters of the voltage generator (such as a resistance of a common resistor or a specification of the thermistor) must be adjusted so the characteristic curves of the gate driving voltages being output may be adjusted accordingly, which is quite inconvenient. In addition, when adjusting characteristic curves of the gate driving voltages, since there are too many hardware parameters need to be set, resulting the gate driving voltage being compensated being different from to an ideal setting.

### SUMMARY OF THE INVENTION

The invention provides a reference voltage generator and a reference voltage generating method for adjusting a characteristic curve of a gate driving voltage by calculation of circuits.

The invention provides a reference voltage generator of a gate driving circuit. The reference voltage generator includes a temperature sensing unit, a level clamp unit, a gain adjusting unit and a computing circuit. The temperature sensing unit generates a temperature sensing voltage in response to an environmental temperature. The level clamp unit is coupled to the temperature sensing unit. The level clamp unit provides a difference signal in response to the temperature sensing voltage. The gain adjusting unit is used to provide a temperature compensating gain and a first reference level. The gain adjusting unit adjusts the temperature compensating gain and the first reference level according to a control command. The computing circuit is coupled to the level clamp unit and the gain adjusting unit to provide a reference voltage in response to the temperature compensating gain, the first reference level and the difference signal.

According to an embodiment of the invention, the temperature sensing unit includes a current source, a first resistor, a second resistor and a thermistor. The first resistor has a first terminal coupled to the current source. The second resistor has a first terminal coupled to a second terminal of the first resistor, and a second terminal coupled to a grounding voltage. The thermistor has a first terminal coupled to a second terminal of the first resistor and the first terminal of the second resistor, and a second terminal of the thermistor is coupled to a grounding voltage. The thermistor has a negative temperature coefficient, and the temperature sensing voltage is generated in response to a current flowed through the first resistor, the second resistor and the thermistor.

According to an embodiment of the invention, the reference voltage is at the first reference level when the environmental temperature is greater than or equal to an upper limit temperature, and the reference voltage is at a second reference level when the environmental temperature is less than or equal to a lower limit temperature. Resistances of the first resistor and the second resistor are not affected by the first reference level and the second reference level.

According to an embodiment of the invention, the reference voltage generator further includes an output unit. The output unit is coupled to the computing circuit and configured to generate a gate driving voltage by boosting or bucking the reference voltage.

According to an embodiment of the invention, the difference signal includes a difference voltage, the level clamp unit restricts a voltage range of the temperature sensing voltage according to the first preset clamp level and the second preset clamp level and generates the difference voltage by calculating a difference between the restricted temperature sensing voltage and the second preset clamp level.

According to an embodiment of the invention, the gain adjusting unit includes a first digital-to-analog converting unit, a storage unit and a gain calculating unit. The first digital-to-analog converting unit is configured to receive the control command for generating the first reference level and a second reference level. The storage unit is coupled to the first digital-to-analog converting unit, in which the storage unit is accessed under control of the control command to control operations of the first digital-to-analog converting unit. The gain calculating unit is coupled to the first digital-to-analog converting unit and configured to calculate the temperature compensating gain according to the first reference level, the second reference level, the first preset clamp level and the second preset clamp level.

According to an embodiment of the invention, the computing circuit includes a multiplication unit and an addition unit. The multiplication unit is coupled to the level clamp unit and the gain calculating unit and configured to calculate a compensating voltage according to the difference voltage and the temperature compensating gain. The addition unit is coupled to the first digital-to-analog converting unit and the multiplication unit and configured to calculate the reference voltage according to the compensating voltage and the first reference level.

According to an embodiment of the invention, the difference signal includes a difference voltage, and the level clamp unit includes an analog-to-digital converting unit. The analog-to-digital converting unit is coupled to the temperature sensing unit and configured to set a digital output range according to a first preset clamp level and a second preset clamp level, and convert the temperature sensing voltage into the digital difference signal based on the digital output range.

According to an embodiment of the invention, the gain adjusting unit includes a first digital-to-analog converting unit and a storage unit. The first digital-to-analog converting unit is configured to receive the control command for generating the first reference level and a second reference level. The storage unit is coupled to the first digital-to-analog converting unit, in which the storage unit is accessed under control of the control command to control operations of the first digital-to-analog converting unit.

According to an embodiment of the invention, the computing circuit includes a second digital-to-analog converting unit. The second digital-to-analog converting unit is coupled to the first digital-to-analog converting unit and the analog-to-digital converting unit and configured to set an analog output range according to the first reference level and the second reference level, and convert the digital difference signal into the reference voltage based on the analog output range.

According to an embodiment of the invention, the gain adjusting unit receives the control command through a digital bi-directional transmitting interface.

A reference voltage generating method, adapted for a gate driving circuit of a liquid crystal display panel, the reference voltage generating method includes: generating a temperature sensing voltage in response to an environmental temperature; providing a difference signal in response to the temperature sensing voltage; providing a temperature compensating gain and a first reference level; adjusting the temperature compensating gain and the first reference level according to a control command; and providing a reference voltage in response to the temperature compensating gain, the first reference level and the difference signal.

According to an embodiment of the invention, the difference signal includes a difference voltage, and the step of providing the difference signal in response to the temperature sensing voltage includes: calculating the difference voltage according to a first preset clamp level, a second preset clamp level and the temperature sensing voltage.

According to an embodiment of the invention, the step of calculating the difference voltage according to the first preset clamp level, the second preset clamp level and the temperature sensing voltage includes: restricting a voltage range of the temperature sensing voltage according to the first preset clamp level and the second preset clamp level; and generating the difference voltage by calculating a difference between the restricted temperature sensing voltage and the second preset clamp level.

According to an embodiment of the invention, the step of adjusting the temperature compensating gain and the first reference level according to the control command includes: generating the first reference level and a second reference level according to the control command; and calculating the temperature compensating gain according to the first reference level, the second reference level, the first preset clamp level and the second preset clamp level.

According to an embodiment of the invention, the step of providing the reference voltage in response to the temperature compensating gain, the first reference level and the difference signal includes: calculating a compensating voltage according to the temperature compensating gain and the difference voltage; and calculating the reference voltage according to the first reference level and the compensating voltage.

According to an embodiment of the invention, the difference signal includes a digital difference signal, and the step of providing the difference signal in response to the temperature sensing voltage includes: setting a digital output range according to a first preset clamp level and a second preset clamp level and converting the temperature sensing voltage into the digital difference signal based on the digital output range.

According to an embodiment of the invention, the step of adjusting the temperature compensating gain and the first reference level according to the control command includes: generating the first reference level and a second reference level according to the control command; and setting an analog output range according to the first reference level and the second reference level.

According to an embodiment of the invention, the step of providing the reference voltage in response to the temperature compensating gain, the first reference level and the difference signal includes: converting the digital difference signal into the reference voltage based on the analog output range.

According to an embodiment of the invention, the reference voltage generating method further includes: generating a gate driving voltage by boosting or bucking the reference voltage.

In view of above, the embodiments of the invention provides to a reference voltage generator and a reference voltage generating method. The reference voltage generator may dynamically adjust a restricted range of the reference voltage according to a control command being received. Since a resistance of the temperature sensing unit does not required to be adjusted to thereby change the restricted range of the reference voltage, so that variables for designing the circuit may be reduced. As a result, the reference voltage being output may be more accurate to allow the reference voltage generator to be more adaptable for module design.

To make the above features and advantages of the invention more comprehensible, several embodiments accompanied with drawings are described in detail as follows.

### BRIEF DESCRIPTION OF THE DRAWINGS

FIG. 1A is a schematic view of a reference voltage generator according to an embodiment of the invention.

FIG. 1B is a schematic view of a gate driving voltage according to an embodiment of the invention.

FIG. 2A is a schematic view of a reference voltage generator according to another embodiment of the invention.

FIGS. 2B to 2E are schematic views of each node voltage according to the embodiment of FIG. 2A.

FIG. 3 is a schematic view of a reference voltage generator according to yet another embodiment of the invention.

FIG. 4 is a flowchart of a reference voltage generating method according to an embodiment of the invention.

FIG. 5 is a flowchart of a reference voltage generating method according to another embodiment of the invention.

FIG. 6 is a flowchart of a reference voltage generating method according to yet another embodiment of the invention.

### DETAILED DESCRIPTION

A reference voltage generator and a reference voltage generating method are proposed in view of the embodiments of the invention. The reference voltage generator may dynamically adjust a restricted range of the reference voltage according to a control command being received. Since a resistance of the temperature sensing unit does not required to be adjusted to thereby change the restricted range of the reference voltage, so that variables for designing the circuit may be reduced. As a result, the reference voltage being output may be more accurate, and the reference voltage generator may be more adaptable for module design. In order to make the invention more comprehensible, embodiments are described below as the examples to prove that the invention can actually be realized. Moreover, elements/components/steps with same reference numerals represent same or similar parts in the drawings and embodiments.

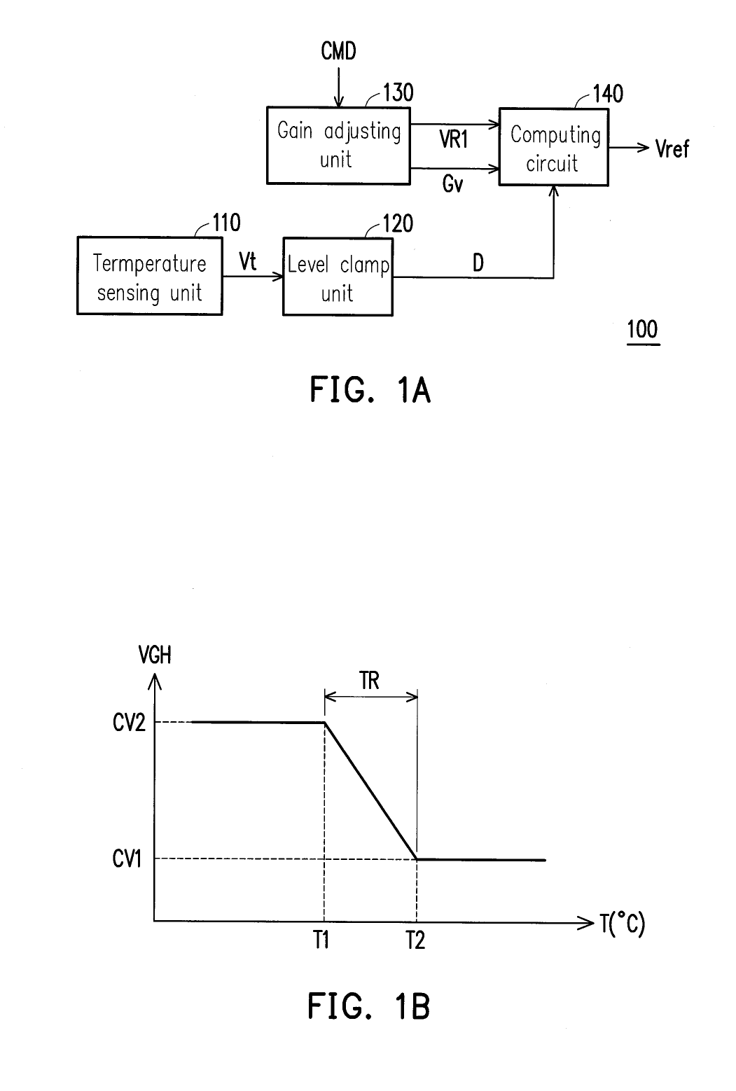

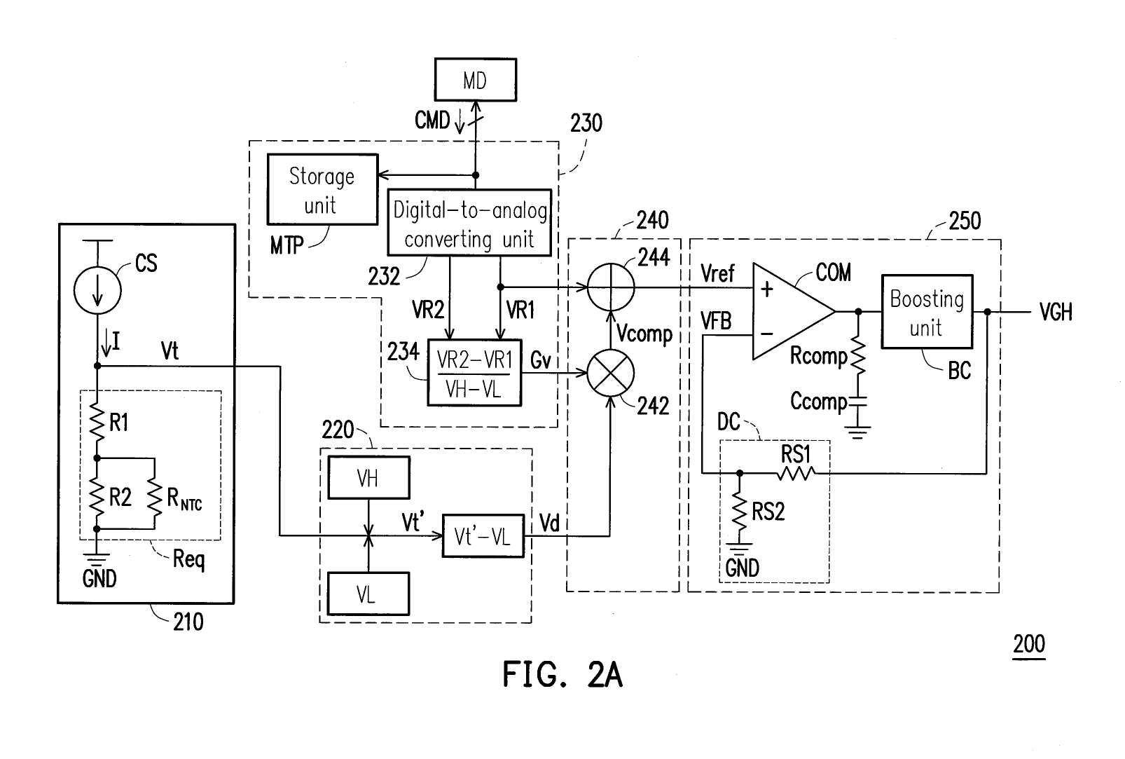

FIG. 1A is a schematic view of a reference voltage generator according to an embodiment of the invention. According to the present embodiment, a reference voltage generator 100 is adapted to provide a reference voltage Vref having a low temperature compensation for a gate driving circuit of a LCD panel (not illustrated), in which the gate driving circuit may generate a gate driving voltage (e.g., VGH) according to the reference voltage Vref, so as to compensate a characteristics deviation of the gate driving circuit (especially when it is a Gate in panel (GIP) gate driving circuit) under low temperature. FIG. 1B is a schematic view of a gate driving voltage according to an embodiment of the invention.

Referring to FIG. 1A and FIG. 1B together, the reference voltage generator 100 includes a temperature sensing unit 110, a level clamp unit 120, a gain adjusting unit 130 and a computing circuit 140. The temperature sensing unit 110 generates a temperature sensing voltage Vt in response to an environmental temperature T. The level clamp unit 120 is coupled to the temperature sensing unit 110 and providing a difference signal D in response to the temperature sensing voltage Vt.

The gain adjusting unit 130 is configured to provide a temperature compensating gain Gv and a first reference level VR1, in which the gain adjusting unit 130 adjusts a temperature compensating gain Gv and the first reference level VR1 according to a control command CMD.

The computing circuit 140 is coupled to the level clamp unit 120 and the gain adjusting unit 130 to provide a reference voltage Vref in response to the temperature compensating gain Gv, the first reference level VR1 and the difference signal D. Accordingly, an output unit (not illustrated) at back end may generate a gate driving voltage VGH by boosting or bucking the reference voltage Vref output by the reference voltage generator 100. The gate driving voltage VGH in a preset temperature range TR is negatively related to that in the environmental temperature T, the reference voltage generator 100 may restrict the gate driving voltage VGH at a first clamp level CV1 when the environmental temperature T is greater than or equal to an upper limit temperature T2, whereas the level clamp unit 120 may restrict the gate driving voltage VGH at a second clamp level CV2 when the environmental temperature T is less than or equal to a lower limit temperature T1.

According to the present embodiment, magnitudes of the first clamp level CV 1 and the second clamp level CV2 are set by the gain adjusting unit 130 according to the control command CMD. More specifically, a user may select specific values for the first clamp level CV1 and the second clamp level CV2 through a software application on a control device (e.g., PC or notebook PC, not illustrated) externally. The control device may transmit the corresponding control command CMD to the gain adjusting unit 130 through a digital bi-directional transmitting interface (e.g., I2C or USB, etc.), such that the gain adjusting unit 130 may adjust the temperature compensating gain Gv and the first reference level VR1 to set the first clamp level CV1 and the second clamp level CV2.

Specifically, due to characteristics differences in process and specifications, voltage values of the gate driving voltage required for normal operations and values of the gate driving voltage having low temperature compensation for different gate driving circuits are all different to each other. Therefore, in a common voltage generator having temperature compensating function, hardware specifications (e.g., resistance) need to be adjusted in order to set the magnitudes of the first clamp level CV1 and the second clamp level CV2, which is inconvenient to designers.

Compared with the conventional voltage generator having temperature compensating function, the reference voltage generator 100 of the present embodiment may dynamically set the magnitudes of the first clamp level CV1 and the second clamp level CV2 according to the control command CMD received, such that the gate driving voltage VGH which is compatible with various specifications of the gate driving circuits may be provided without changing hardware settings of the reference voltage generator 100.

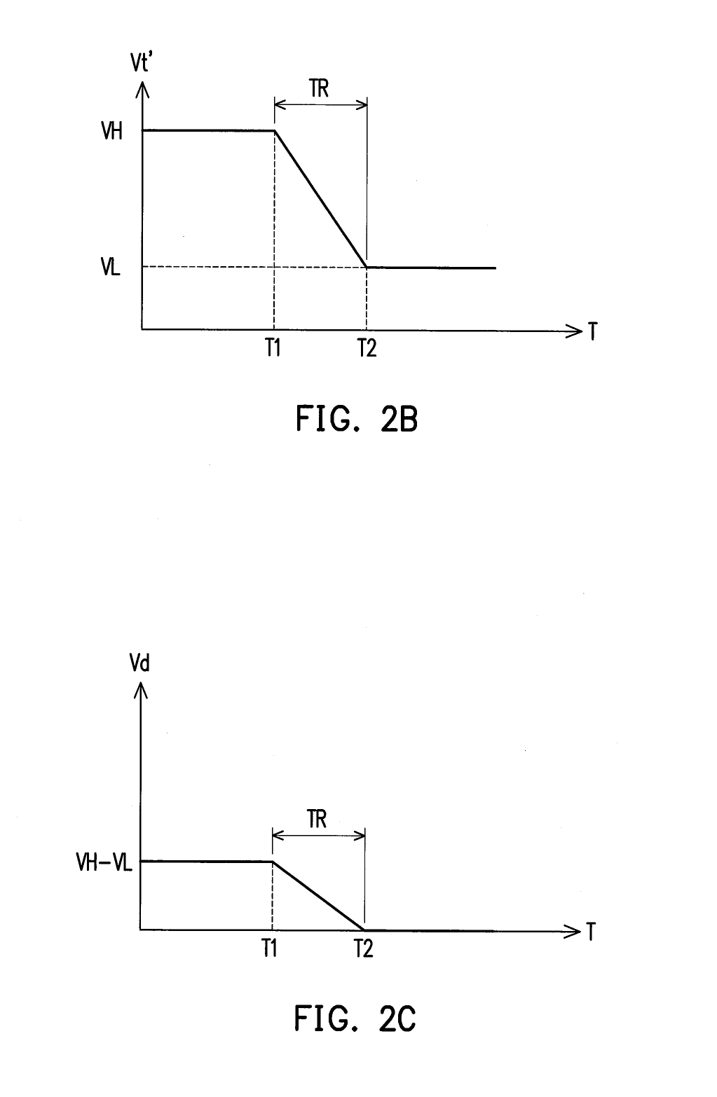

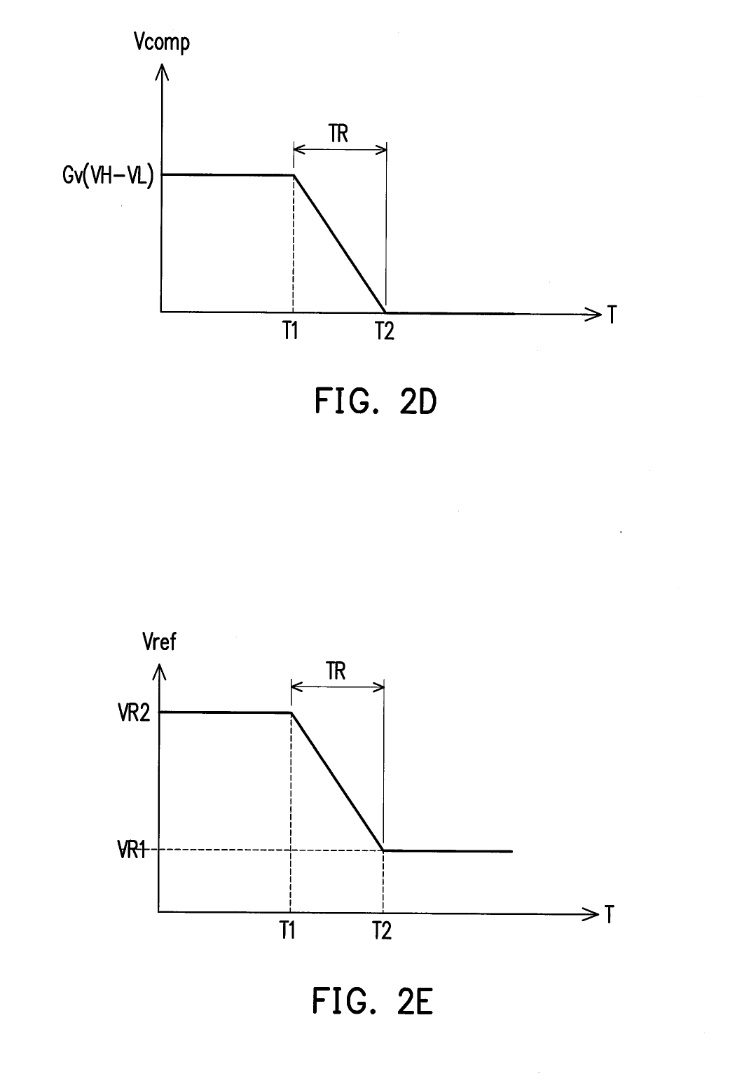

FIG. 2A is a schematic view of a reference voltage generator according to another embodiment of the invention. In addition, it is also described hereinafter with reference to the gate driving voltage VGH as illustrated in FIG. 1B. Referring to FIG. 1B and FIG. 2A together, a reference voltage generator 200 includes a temperature sensing unit 210, a level clamp unit 220, a gain adjusting unit 230, a computing circuit 240 and an output unit 250. The temperature sensing unit 210 includes a current source CS, a first resistor R1, a second resistor R2 and a thermistor R_{NTC}. The first resistor R1 has a first terminal coupled to the current source CS. The second resistor R2 has a first terminal coupled to a second terminal of the first resistor R1, and a second terminal of the second resistor R2 is coupled to a grounding voltage GND. A first terminal of the thermistor R_{NTC} is coupled to the second terminal of the first resistor R1 and the first terminal of the second resistor R2, and a second terminal of the thermistor R_{NTC} is coupled to the grounding voltage GND, in which the thermistor R_{NTC} has a negative temperature coefficient (i.e., a resistance inversely proportional to temperature). Based on above said structure, the temperature sensing voltage Vt may be generated in response to a current I flowed through the first resistor R1, the second resistor R2 and the thermistor R_{NTC}, in which a voltage value of the temperature sensing voltage Vt may be negatively related to the temperature based on variation of the resistance of the thermistor R_{NTC}.

The level clamp unit 220 is used to calculate a difference voltage Vd according to a first preset clamp level VH, a second preset clamp level VL and the temperature sensing voltage Vt. According to the present embodiment, the level clamp unit 220 may restrict a voltage range of the temperature sensing voltage Vt according to the first preset clamp level VH and the second preset clamp level VL and generates the difference voltage Vd by calculating a difference between the restricted temperature sensing voltage Vt′ and the second preset clamp level VL.

More specifically, the user may set the first preset clamp level VH and the second preset clamp level VL properly according to a preset temperature range TR for compensation. The user may adjust resistances of the first resistor R1 and the second resistor R2 according to both the first preset clamp level VH and the second preset clamp level VL being set, such that the temperature sensing voltage Vt may correspond to the first preset clamp level VH when the environmental temperature T is at the lower limit temperature T1 and correspond to the second preset clamp level VL when the environmental temperature T is at the upper limit temperature T2. Since the first preset clamp level VH and the second clamp level VL are fixed values after being set, the resistances of the resistor R1 and the second resistor R2 does not required to be respectively adjusted again according to different clamp levels once said adjustment is completed. In other words, the resistances of the first resistor R1 and the second resistor 2 are not affected by the magnitudes of the first reference level VR1 (the first clamp level CV1) and the second reference level VR2 (the second clamp level CV2).

For instance, it is assumed that the current source CS in the temperature sensing unit 210 provides the fixed current being 50 uA, the first clamp level VH and the second clamp level VL are respectively set to 1.7V and 1.2V and the specification of the thermistor R_{NTC} is R25=10KΩ, B=3435. Under a condition of the preset temperature range TR being −10° C. to 0° C., the resistances of the first resistor R1 and the second resistor R2 may be set as below:

| R_{NTC} (−10° C.) | R_{NTC} (0° C.) | R1 | R2 |
|---|---|---|---|
| 46366.44 Ω | 28736.18 Ω | 1058.22 Ω | 113775.15 Ω |

The gain adjusting unit 230 includes a digital-to-analog converting unit 232, a gain calculating unit 234 and a storage unit MTP. The digital-to-analog converting unit 232 is configured to receive the control command CMD thereby converting and generating the first reference level VR1 and the second reference level VR2, Wherein the first reference level VR1 and the second reference level VR2 have a proportional relation with the first clamp level CV1 and the second clamp level CV2 in the present embodiment, so that the gate driving voltage having the first clamp level CV1 and the second clamp level CV2 may be generated after boosting/bucking the reference voltage Vref through the output unit 250. In the present embodiment, the user may send the control command CMD by a control device MD to control the digital-to-analog converting unit 232, such that the digital-to-analog converting unit 232 generates the first reference level VR1 and the second reference level VR2 accordingly. Alternatively, the user may send the control command CMD to access the storage unit MTP, such that the storage unit MTP may transmit a corresponding command to the digital-to-analog converting unit 232 to allow the digital-to-analog converting unit 232 to generate the first reference level VR1 and the second reference level VR2 correspondingly. A control method for the control command CMD to generate the first reference level VR1 and the second reference level VR2 is not particularly limited in the invention.

In addition, said proportional relation is only set in coordination with a voltage operating range of the level clamp unit 220. For instance, when the first clamp level CV1 and the second clamp level CV2 are respectively being 20V and 30V, the digital-to-analog converting unit 232 may generate the first reference level VR1 being 2V and the second reference level VR2 being 3V according to the control command CMD, so that the level clamp unit 220 may be operated within a relatively lower voltage range. However, such proportional relation may be adjusted based on circuit design, the invention is not limited thereto.

The gain calculating unit 234 is coupled to the digital-to-analog converting unit 232 and configured to calculate the temperature compensating gain Gv according to the first reference level VR1, the second reference level VR2, the first preset clamp level VH and the second preset clamp level VL. More specifically, the gain calculating unit 234 may calculate the temperature compensating gain Gv by dividing a difference between the reference voltages VR1 and VR2 by a difference between the preset clamp levels VH and VL, that is, Gv=(VR2−VR1)/(VH−VL). Since the first preset clamp level VH and the second clamp level VL are the fixed values, the gain calculating unit 234 may calculate different values of the temperature compensating gain Gv according to the different first reference level VR1 and the different second reference level VR2.

The computing circuit 240 includes a multiplication unit 242 and an addition unit 244. The multiplication unit 242 is coupled to the level clamp unit 220 and the gain calculating unit 234 and configured to calculate a compensating voltage Vcomp according to the difference voltage Vd and the temperature compensating gain Gv. The addition unit 244 is coupled to the digital-to-analog converting unit 232 and the multiplication unit 242 and configured to calculate the reference voltage Vref according to the compensating voltage Vcomp and the first reference level VR1.

The output unit 250 is coupled to the addition unit 244 and configured to generate the gate driving voltage VGH by boosting or bucking the reference voltage Vref according to the proportional relation between the reference levels (VR1 and VR2) and the clamp levels (CV1 and CV2). In the present embodiment, the output unit 250 is illustrated with a circuit structure including a comparator COM, a compensating resistor Rcomp and a compensating capacitor Ccomp, a boost circuit BC and a division circuit DC as an example In which, the boost circuit BC may boost the reference voltage Vref to a level of gate driving voltage VGH, and a feedback circuit structure of the division circuit DC and the comparator COM may be used to buck the gate driving voltage VGH according to said proportional relation and output as a feedback voltage VFB through the division circuit DC, so that the comparator COM may compare levels of the reference voltage Vref and the feedback voltage VFB for outputting the gate driving voltage VGH stably. However, the circuit structure of the output unit 250 is merely an example for describing the embodiment, the invention is not limited thereto.

To explain the present embodiment of the invention more clearly, referring to FIGS. 2B to 2E which are schematic views of each node voltage in the embodiment of FIG. 2A. Referring to FIGS. 2A to 2E together, after the level clamp unit 220 receives the temperature sensing voltage Vt, the level clamp unit 220 may restrict the temperature sensing voltage Vt to fall between the first preset clamp level VH and the second preset clamp level VL. A characteristic curve of the restricted temperature sensing voltage Vt′ is as shown in FIG. 2B, in which the restricted temperature sensing voltage Vt′ is at the first preset clamp level VH when the environmental temperature T is lower than or equal to the lower limit temperature T1, and the restricted temperature sensing voltage Vt′ is at the second clamp level VL when the environmental temperature T is higher than or equal to the upper limit temperature T2.

Afterwards, the level clamp unit 220 may calculate a difference between the restricted temperature sensing voltage Vt′ and the second clamp level VL to output the difference voltage Vd as shown in FIG. 2C, in which the difference voltage Vd is decreased to 0V when the environmental temperature T is greater than or equal to the upper limit temperature T2 and the difference voltage Vd is restricted at a level of VH-VL when the environmental temperature T is less than or equal to the lower limit temperature T1. Next, the multiplication unit 242 may multiply the difference voltage Vd by the temperature compensating gain Gv to obtain a compensating voltage Vcomp as shown in FIG. 2D, in which since the temperature compensating gain Gv is (VR2−VR1)/(VH−VL), so that a level of the compensating voltage Vcomp is the difference between the first reference level VR1 and the second reference level VR2 (VR2−VR1) when the environmental temperature T is less than the lower limit temperature T1.

After the compensating voltage Vcomp is calculated, the addition unit 244 may add the first reference VR1 and the compensating voltage Vcomp together to output the reference voltage Vref as shown in FIG. 2E, in which the reference voltage Vref is restricted at the first reference level VR1 when the environmental temperature T is greater than or equal to the upper limit temperature T2, and the reference voltage Vref is restricted at the second reference level VR2 when the environmental temperature T is less than or equal to the upper limit temperature T1, and the reference voltage Vref is inversely proportional to the environmental temperature T when the environmental temperature T falls within the preset temperature range TR. Therefore, the output unit 250 may output the gate driving voltage VGH after boosting or bucking the reference voltage Vref according to said proportional relation.

Based on the voltage generating method above, regardless of whatever values of the first clamp level CV1 and the second clamp level CV2 are set by the user, different characteristic curves of the gate driving voltage VGH may be generated by the calculation of the circuits without changing any hardware parameters.

For instance, it is described hereinafter by setting the first preset clamp level VH and the second clamp level VL respectively to 2V and 1V, the lower limit temperature T1 to −10° C., the upper limit temperature T2 to 0° C. and the proportional relation to 1:10 (i.e., the reference levels VR1 and VR2 are respectively 1/10 of the clamp levels CV1 and CV2) as an example. In case when the user respectively sets the first clamp level CV1 and the second clamp level CV2 of the gate driving voltage VGH to two different set of values in which one set of values being 20V and 30V while another set of values being 25V and 40V, since the first preset clamp level VH and the second clamp level VL may not be changed due to settings of the clamp levels, so that the level clamp unit 220 may output an identical difference voltage Vd according to the temperature sensing voltage Vt under said two sets of the clamp levels.

On the other hand, since the clamp levels CV 1 and CV2 are set differently, so that the gain calculating unit 324 may calculate the corresponding temperature compensating gain Gv according to the difference between the corresponding reference levels, in which the temperature compensating gain Gv generated by the gain calculating unit 234 is 1 when the first clamp level CV1 and the second clamp level CV2 are respectively set to 20V and 30V; and the temperature compensating gain Gv generated by the gain calculating unit 234 is 1.5 when the first clamp level CV1 and the second clamp level CV2 are respectively set to 25V and 40V. Therefore, the multiplication unit 242 may adjust a slope of the difference voltage Vd within the preset temperature range TR according to different temperature compensating gains Gv, so that the compensating voltage Vcomp and the gate driving voltage VGH may have an identical level-temperature relation within the preset temperature range TR.

Next, the addition unit 244 may shift a characteristic curve of the compensating voltage Vcomp according to the first reference VR1 for outputting as the reference voltage Vref. In which, when the first clamp level CV1 and the second clamp level are respectively set to 20V and 30V, the reference voltage Vref is restricted in between 2V and 3V and negatively related to a line having a slope of 0.1V/° C. with respect to the environmental temperature T within the preset temperature range TR. In addition, when the first clamp level CV1 and the second clamp level CV2 are respectively set to 25V and 40V, the reference voltage Vref is restricted in between 2.5V and 4V and negatively related to a line having a slope of 0.15V/° C. with respect to the environmental temperature T within the preset temperature range TR. In other words, the reference voltage Vref and the gate driving voltage VGH set are only different in proportional relations.

Therefore, the output unit 250 may boost the reference voltage Vref according to said proportional relation of 1:10 thereby respectively generating the gate driving voltage VGH having the first clamp level CV1 being 20V and the second clamp level CV2 being 30V as well as the gate driving voltage VGH having the first clamp level CV1 being 25V and the second clamp level CV2 being 40V.

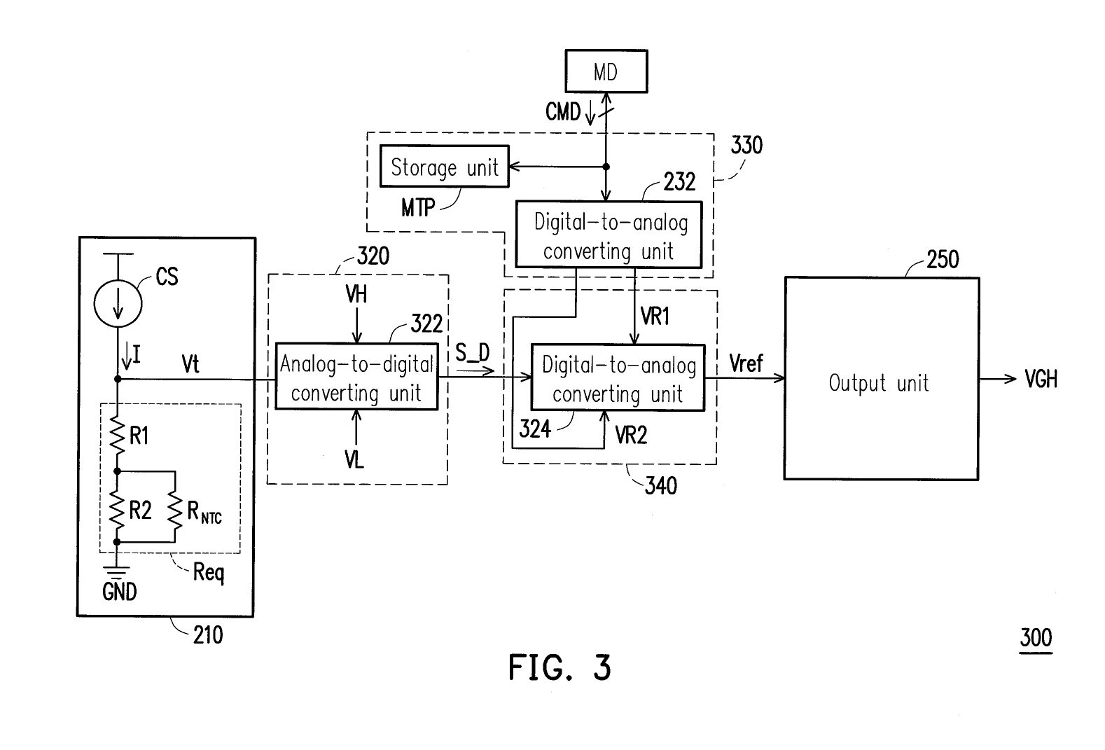

FIG. 3 is a schematic view of a reference voltage generator according to yet another embodiment of the invention. Referring to FIG. 3, a reference voltage generator 300 includes a temperature sensing unit 210, a level clamp unit 320, a gain adjusting unit 330, a computing circuit 340 and the output unit 250. The level clamp unit 320 includes an analog-to-digital converting unit 322. The gain adjusting unit 330 includes the digital-to-analog converting unit 232 and the storage unit MTP. The computing circuit 340 includes a digital-to-analog converting unit 324. In which, the temperature sensing unit 210, the output unit 250, the digital-to-analog converting unit 232, the storage unit and signal transmission control methods between the control command CMD and the gain adjusting unit 330 are fully disclosed by teachings of the embodiment in FIG. 2A, thus it is omitted herein. In the present embodiment, only the major differences to the previous embodiments are further described.

In the level clamp unit 320, the analog-to-digital converting unit 322 sets a digital output range according to the first preset clamp level VH and the second preset clamp level VL and converts the temperature sensing voltage Vt into a digital difference signal S_D based on the digital output range. In other words, after analog-to-digital converting the temperature sensing voltage Vt, a voltage greater than or equal to the first reset clamp level VH is converted into the digital difference signal S_D corresponding to the first preset clamp level VH, whereas a voltage less than or equal to the second reset clamp level VL is converted into the digital difference signal S_D corresponding to the second preset clamp level VL.

In the computing circuit 340, the digital-to-analog converting unit 324 is coupled to the digital-to-analog converting unit 232 and the analog-to-digital converting unit 322 to receive the first reference level VR1, the second reference level VR2 and the digital difference signal S_D. In which, the digital-to-analog converting unit 324 may set an analog output range according to the first reference level VR1 and the second reference level VR2 and convert the digital difference signal S_D into the reference voltage Vref based on the analog output range being set, thereby converting the digital difference signal S_D corresponding to the first preset clamp level VH into the voltage corresponding to the second reference level VR2; converting the digital difference signal S_D corresponding to the second preset clamp level VL into the voltage corresponding to the first reference level VR1; and converting the digital difference signal S_D corresponding to the level between the first preset clamp level VH and the second preset clamp level VL into the voltage corresponding to the voltage which falls within the analog output range according to a resolution of digital-to-analog conversion.

Next, the output unit 250 may output the gate driving voltage VGH after boosting or bucking the reference voltage Vref being output by the digital-to-analog converting unit 324. More specifically, when different clamp levels are set by the user, the digital-to-analog converting unit 324 may adjust the voltage corresponding to the digital difference signal S_D according to the corresponding analog output range, so as to adjust the characteristic curve of the gate driving voltage VGH.

According to the present embodiment, said resolution is decided based on bit numbers of the analog-to-digital converting unit 322 and the digital-to-analog converting unit 324. For instance, in regard to the analog-to-digital converting unit 322 and the digital-to-analog converting unit 324 of N bits, the resolution thereof is the difference between the first reference level VR1 and the second reference VR2 being divided by N, in which N is a positive integer and may be decided base on design requirements.

In addition, the level clamp units 220 and 320 as described in FIG. 2A and FIG. 3 may both be integrated on a chip. In a circuit layout of the integrated level clamp units 220 and 320, only a receive pin of the temperature sensing voltage Vt and an output pin of the gate driving voltage VGH are required without setting magnitudes of the clamp level of the gate driving voltage VGH by having additional setting pins, such that a complication of an overall circuit layout may be substantially reduced. On the other hand, since there is no need to consider the proportion of the first resistor R1 and the second resistor R2, so that variables in design the circuit may be reduced, and the gate driving voltage VGH may also be closer to the level which being preset.

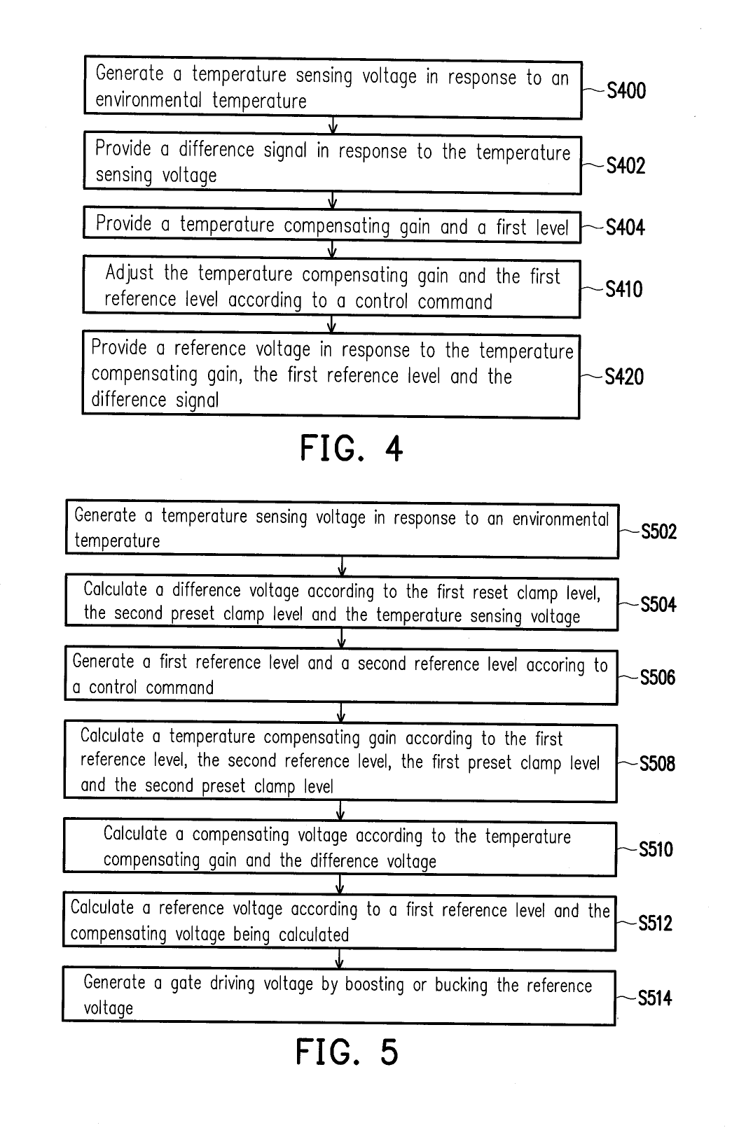

FIG. 4 is a flowchart of a reference voltage generating method according to an embodiment of the invention. Referring to FIG. 4, in the reference voltage generating method in FIG. 4, the reference voltage generator (e.g., the reference voltage generators 100, 200 or 300) may generate a temperature sensing voltage in response to an environmental temperature (step S400), and provide a difference signal in response to the temperature sensing voltage (step S402). On the other hand, the reference voltage generator may provide a temperature compensating gain and a first reference level (step S404), and adjust the temperature compensating gain and the first reference level according to a control command sent by a user (step S410). Therefore, a reference voltage may be provided in response to the temperature compensating gain, the first reference level and the difference signal (step S420).

Herein, sequences between steps S400 to S402 and between steps S404 to S410 may be adjusted or performed at the same time based on circuit design, the invention is not limited thereto.

FIG. 5 is a flowchart of a reference voltage generating method according to another embodiment of the invention. Referring to FIG. 5, in the reference voltage generating method in FIG. 5, the user may preset a first preset clamp level and a second preset clamp level of the referenced voltage generator (e.g., the reference voltage generator 200) according to a preset temperature range for compensation. When generating voltage, the reference voltage generator may first generate a temperature sensing voltage in response to an environmental temperature (step S502), and calculate a difference voltage according to the first reset clamp level, the second preset clamp level and the temperature sensing voltage (step S504). More specifically, in step S504, the reference voltage generator may restrict a voltage range of the temperature sensing voltage according to the first preset clamp level and the second preset clamp level, and obtain said difference voltage by calculating a difference between the restricted temperature sensing voltage and the second preset clamp level.

Next, the reference voltage generator may generate a first reference level and a second reference level according to a control command (step S506), and calculate a temperature compensating gain according to the first reference level, the second reference level, the first preset clamp level and the second preset clamp level (step S508). In addition, step S504 and steps S506 to S508 may respectively performed by different circuit in the reference voltage generator to be performed at the same time or sequentially, the invention is not limited thereto.

After the temperature compensating gain and the difference voltage are calculated, the reference voltage generator may further calculate a compensating voltage according to the temperature compensating gain and the difference voltage (step S510), and calculate a reference voltage according to a first reference level and the compensating voltage being calculated (step S512). Lastly, the reference voltage generator may then generate a gate driving voltage by boosting or bucking the reference voltage (step S514).

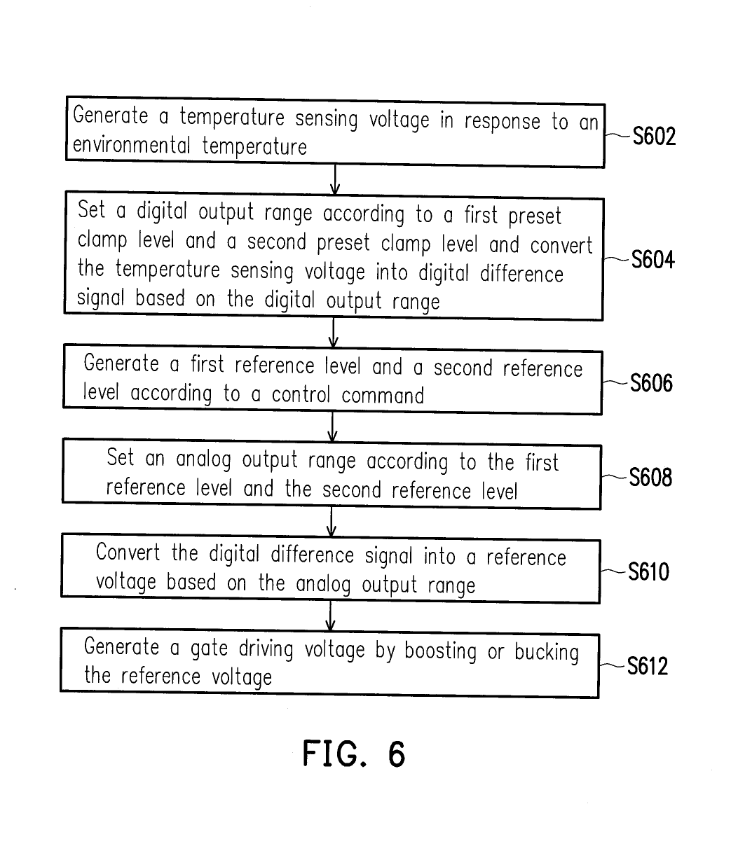

FIG. 6 is a flowchart of a reference voltage generating method according to yet another embodiment of the invention. Referring to FIG. 6, in the reference voltage generating method in FIG. 6, the user may preset a first preset clamp level and a second preset clamp level of the referenced voltage generator (e.g., the reference voltage generator 300) according to a preset temperature range for compensation. When generating voltage, the reference voltage generator may first generate a temperature sensing voltage in response to an environmental temperature (step S602), and set a digital output range according to a first preset clamp level and a second preset clamp level and convert the temperature sensing voltage into digital difference signal based on the digital output range (step S604).

Next, the reference voltage generator may generate a first reference level and a second reference level according to a control command (step S606), so as to set an analog output range according to the first reference level and the second reference level (step S608) and convert the digital difference signal into a reference voltage based on the analog output range (step S610). Therefore, the reference voltage generator may then generate a gate driving voltage by boosting or bucking the reference voltage according to said proportional relation (step S612).

In which, methods as described in FIG. 4, FIG. 5 and FIG. 6 are fully supported and disclosed by teachings in FIG. 1A to FIG. 3, thus similar or repeated descriptions thereto are omitted hereinafter.

In view of above, the embodiments of the invention provides to a reference voltage generator and a reference voltage generating method. The reference voltage generator may dynamically adjust a restricted range of the reference voltage according to a control command being received. Since a resistance of the temperature sensing unit does not required to be adjusted to thereby change the restricted range of the reference voltage, so that variables for designing the circuit may be reduced. As a result, the reference voltage being output may be more accurate to allow the reference voltage generator to be more adaptable for module design.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A reference voltage generator of a gate driving circuit, comprising:
a temperature sensing unit configured to generate a temperature sensing voltage in response to an environmental temperature;
a level clamp unit coupled to the temperature sensing unit and providing a difference signal in response to the temperature sensing voltage;
a gain adjusting unit configured to provide a temperature compensating gain and a first reference level, wherein the gain adjusting unit adjusts the temperature compensating gain and the first reference level according to a control command; and
a computing circuit coupled to the level clamp unit and the gain adjusting unit to provide a reference voltage in response to the temperature compensating gain, the first reference level and the difference signal.

2. The reference voltage generator of claim 1, wherein the temperature sensing unit comprises:
a current source;
a first resistor having a first terminal coupled to the current source;
a second resistor having a first terminal coupled to a second terminal of the first resistor, and a second terminal coupled to a grounding voltage; and
a thermistor having a first terminal coupled to the second terminal of the first resistor and the first terminal of the second resistor and a second terminal coupled to the grounding voltage, wherein the thermistor has a negative temperature coefficient, and the temperature sensing voltage is generated in response to a current flowed through the first resistor, the second resistor and the thermistor.

3. The reference voltage generator of claim 2, wherein the reference voltage is at the first reference level when the environmental temperature is greater than or equal to an upper limit temperature, and the reference voltage is at a second reference level when the environmental temperature is less than or equal to a lower limit temperature, wherein resistances of the first resistor and the second resistor are not affected by the first reference level and the second reference level.

4. The reference voltage generator of claim 1, further comprising:
an output unit coupled to the computing circuit and configured to generate a gate driving voltage by boosting or bucking the reference voltage.

5. The reference voltage generator of claim 1, wherein the difference signal comprises a difference voltage, the level clamp unit restricts a voltage range of the temperature sensing voltage according to a first preset clamp level and a second preset clamp level and generates the difference voltage by calculating a difference between the restricted temperature sensing voltage and the second preset clamp level.

6. The reference voltage generator of claim 5, wherein the gain adjusting unit comprises:
a first digital-to-analog converting unit configured to receive the control command for generating the first reference level and a second reference level;
a storage unit coupled to the first digital-to-analog converting unit, wherein the storage unit is accessed under control of the control command to control operations of the first digital-to-analog converting unit; and
a gain calculating unit coupled to the first digital-to-analog converting unit and configured to calculate the temperature compensating gain according to the first reference level, the second reference level, the first preset clamp level and the second preset clamp level.

7. The reference voltage generator of claim 6, wherein the computing circuit comprises:
a multiplication unit coupled to the level clamp unit and the gain calculating unit and configured to calculate a compensating voltage according to the difference voltage and the temperature compensating gain; and
an addition unit coupled to the first digital-to-analog converting unit and the multiplication unit and configured to calculate the reference voltage according to the compensating voltage and the first reference level.

8. The reference voltage generator of claim 1, wherein the difference signal comprises a digital difference signal, and the level clamp unit comprises:
an analog-to-digital converting unit coupled to the temperature sensing unit and configured to set a digital output range according to a first preset clamp level and a second preset clamp level, and convert the temperature sensing voltage into the digital difference signal based on the digital output range.

9. The reference voltage generator of claim 8, wherein the gain adjusting unit comprises:
a first digital-to-analog converting unit configured to receive the control command for generating the first reference level and a second reference level; and
a storage unit coupled to the first digital-to-analog converting unit, wherein the storage unit is accessed under control of the control command to control operations of the first digital-to-analog converting unit.

10. The reference voltage generator of claim 9, wherein the computing circuit comprises:
a second digital-to-analog converting unit coupled to the first digital-to-analog converting unit and the analog-to-digital converting unit and configured to set an analog output range according to the first reference level and the second reference level, and convert the digital difference signal into the reference voltage based on the analog output range.

11. The reference voltage generator of claim 1, wherein the gain adjusting unit receives the control command through a digital bi-directional transmitting interface.

12. A reference voltage generating method, adapted for a gate driving circuit of a liquid crystal display panel, the reference voltage generating method comprises:
generating a temperature sensing voltage in response to an environmental temperature;
providing a difference signal in response to the temperature sensing voltage;
providing a temperature compensating gain and a first reference level;
adjusting the temperature compensating gain and the first reference level according to a control command; and
providing a reference voltage in response to the temperature compensating gain, the first reference level and the difference signal.

13. The reference voltage generating method of claim 12, wherein the difference signal comprises a difference voltage, and the step of providing the difference signal in response to the temperature sensing voltage comprises:
calculating the difference voltage according to a first preset clamp level, a second preset clamp level and the temperature sensing voltage.

14. The reference voltage generating method of claim 13, wherein the step of calculating the difference voltage according to the first preset clamp level, the second preset clamp level and the temperature sensing voltage comprises:
restricting a voltage range of the temperature sensing voltage according to the first preset clamp level and the second preset clamp level; and
generating the difference voltage by calculating a difference between the restricted temperature sensing voltage and the second preset clamp level.

15. The reference voltage generating method of claim 13, wherein the step of adjusting the temperature compensating gain and the first reference level according to the control command comprises:
generating the first reference level and a second reference level according to the control command; and
calculating the temperature compensating gain according to the first reference level, the second reference level, the first preset clamp level and the second preset clamp level.

16. The reference voltage generating method of claim 15, wherein the step of providing the reference voltage in response to the temperature compensating gain, the first reference level and the difference signal comprises:
calculating a compensating voltage according to the temperature compensating gain and the difference voltage; and
calculating the reference voltage according to the first reference level and the compensating voltage.

17. The reference voltage generating method of claim 12, wherein the difference signal comprises a digital difference signal, and the step of providing the difference signal in response to the temperature sensing voltage comprises:
setting a digital output range according to a first preset clamp level and a second preset clamp level and converting the temperature sensing voltage into the digital difference signal based on the digital output range.

18. The reference voltage generating method of claim 17, wherein the step of adjusting the temperature compensating gain and the first reference level according to the control command comprises:
generating the first reference level and a second reference level according to the control command; and
setting an analog output range according to the first reference level and the second reference level.

19. The reference voltage generating method of claim 18, wherein the step of providing the reference voltage in response to the temperature compensating gain, the first reference level and the difference signal comprises:
converting the digital difference signal into the reference voltage based on the analog output range.

20. The reference voltage generating method of claim 12, further comprising:
generating a gate driving voltage by boosting or bucking the reference voltage.
